(19) United States
(12) Patent Application Publication
(10) Pub. No.: US 2025/0053428 A1
(43) Pub. Date: Feb. 13, 2025

(54) METHOD FOR SETTING UP A MENU SYSTEM ON A TERMINAL, DEVICE, COMPUTER PROGRAM AND COMPUTER-READABLE MEDIUM

(71) Applicant: Endress+Hauser Conducta GmbH+Co. KG, Gerlingen (DE)

(72) Inventors: Stefan Kempf, Kornwestheim (DE); Stefan Robl, Hünxe (DE)

(21) Appl. No.: 18/798,007

(22) Filed: Aug. 8, 2024

(30) Foreign Application Priority Data
Aug. 10, 2023 (DE) 10 2023 121 430.6

(51) Int. Cl. G06F 9/451; G06F 3/0482; G06F 3/0483

(52) U.S. Cl. CPC G06F 9/451; G06F 3/0482; G06F 3/0483

(57) ABSTRACT

The present disclosure discloses a method for setting up a menu system on a terminal designed to display information from a sensor. The method includes providing a universal base set of menu elements designed to implement all use cases of the menu system, including the displaying of information and the editing of settings on a minimal system. The method also includes providing at least a first extended set and/or a higher-order extended set of menu elements, providing an alternative description for this solely using the base set of menu elements, and checking the technical capabilities of the terminal. Further, the method includes displaying the information on the terminal using the highest-order extended set for which the terminal has the technical capabilities, or displaying the information using the next-lowest extended set or the base set if the terminal is not able to display an extended set.

### CROSS-REFERENCE TO RELATED APPLICATION

The present application is related to and claims the priority benefit of German Patent Application No. 10 2023 121 430.6, filed on Aug. 10, 2023, the entire contents of which are incorporated herein by reference.

### TECHNICAL FIELD

The present disclosure relates to a method for setting up a menu system on a terminal, a device for carrying out the method, a computer program, and a computer-readable medium.

### BACKGROUND

DE 10 2016 124 326 discloses a method for operating a measuring transducer in process automation technology. A measuring transducer is sometimes also called a transmitter. DE 10 2016 124 326 describes the subsequent expandability of a measuring transducer without having to replace its operating software. The described transmitter can load and run “apps.”

The above-described apps usually come with a menu system that is designed to be displayed on a wide range of transmitters and devices. For example, an app for processing measured values for pH sensors should be operable on devices with the smallest monochrome display, devices with medium-sized monochrome displays, and devices with larger color displays that use modern web technologies for user interface rendering.

DE 10 2017 109 711 discloses a method for setting up a menu system on a measuring transducer.

The mentioned system categories also differ greatly in terms of operating options, such as 2-button operation, 4-way softkey operation with a navigator, and free multi-touch operation or mouse/keyboard operation.

In addition, menu systems of transmitters are constantly evolving and adding new menu elements to improve the presentation of information. However, newer apps that use the new menu elements should still be usable on older transmitters that are not yet familiar with or cannot display these new menu elements.

### SUMMARY

The present disclosure is based on the object of making novel menu systems for modern measuring transducers executable even on older or smaller measuring transducers, and of simplifying the maintenance and programming of menu systems.

The object is achieved by a method for setting up a menu system on a terminal, wherein the terminal is designed at least to display information from a sensor of process automation technology, such as measured values from the sensor, the menu system comprising menu pages with menu elements, the method comprising the steps of: providing a universal base set of menu elements, wherein the base set is designed to implement all use cases of the menu system, such as the display of information and editing of settings, and is able to be displayed on a minimal system; providing at least a first extended set and/or a higher-order extended set of menu elements, and providing an alternative description for this solely using the base set of menu elements; checking the technical capabilities of the terminal; and displaying the information on the terminal using the highest-order extended set for which the terminal has the technical capabilities, or displaying the information using the next-lowest extended set or the base set if the terminal is not able to display an extended set.

This allows elements of a menu system to be coded for terminal apps so that they can be displayed on a variety of very different app-enabled terminals.

One embodiment provides that the base set is designed to be barrier-free, such as Braille- and speech-output-compatible.

One embodiment provides that the base set comprises at least one of the following basic elements: menu pages linked in a tree structure, wherein a menu page is a list of rows; abstract navigation to navigate cyclically through the rows; rows that represent a reference to a sub- or top-page, such as a “selection” of the row leads to the referenced page; rows that represent pure text; rows that represent only readable parameters including the associated name/label text; rows that represent only editable parameters including the associated name/label text; rows that represent buttons for controlling actions; or texts in greatly abbreviated and longer form.

One embodiment provides that the base set is designed to be scriptable, i.e., designed for script creation and script processing, and the associated script is part of the alternative description.

One embodiment provides that the script includes one or more of the following options: use of variables, visibility and (de)activation of elements, access to contents of number and text fields, changes to the contents of number and text fields, input validation functions, reactions to events, such as pressing/releasing control elements, changing values, navigation, and (de)selection of a menu element.

One embodiment provides that the alternative description of an extended set is defined individually for each instance of a menu element.

One embodiment provides that menu elements are extended by optional attributes to make them backwards compatible.

The object is further achieved by a device, such as a measuring transducer, which is designed to carry out the method as described above.

The object is further achieved by a computer program comprising instructions which cause the device as described above to carry out at least some of the method steps as described above. The menu system with the menu pages and the base set including basic elements is defined by a user and then saved in a data format as a concrete menu system. The computer program therefore does not carry out the entire method itself, but rather interprets it. The executing computer program thus carries out the steps of the method that relate to the menu display and navigation.

The aim is further achieved by a computer-readable medium on which the computer program as described above is stored.

### BRIEF DESCRIPTION OF THE DRAWINGS

This is explained in more detail with reference to the following figures.

FIG. 1 shows a menu page constructed using the base set.

FIG. 2 shows a menu page constructed using an extended set.

FIG. 3 shows an alternative description of the menu page of FIG. 2.

FIG. 4 shows a measuring transducer.

In the figures, the same features are labeled with the same reference signs.

### DETAILED DESCRIPTION

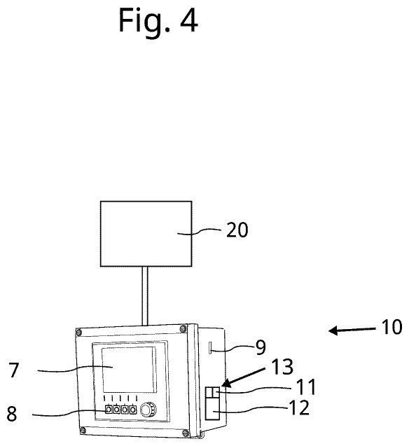

The measuring transducer in FIG. 4 will be discussed first. Generally speaking, a measuring transducer 10, also called a transmitter, is a device that converts an input variable into an output variable according to a fixed relationship. “Measuring transducer” and “transmitter” are used synonymously herein. A sensor is connected to a measuring transducer. Its raw measured values are processed in the measuring transducer, e.g., averaged or converted by means of a computation model to another variable—for example, the process variable to be determined—and possibly transmitted—to a control system, for example.

A wide variety of sensors (not shown) can be connected to the measuring transducer 10. Under the aforementioned name, “Memosens,” the applicant markets sensors for measuring pH value, conductivity, oxygen, turbidity, and other things.

The measuring transducer can also be an integral part of a sensor.

The measurement principle implemented in sensors can often be used in more applications than originally provided. For example, a turbidity sensor which was actually developed for the measurement of sludges in the field of wastewater would also be able to measure fat content in milk by using the measurement principle. In order to be able to flexibly provide new applications, the corresponding models are not permanently saved in the sensor, but can be reloaded in the form of apps 11. The app 11 is thus a (re) loadable piece of program code which offers additional or different functions to the measuring transducer. The firmware of the measuring transducer is therefore designed such that apps can be received, (internally) stored, and executed via an interface.

One or more of the mentioned sensors can be connected to a measuring transducer 10, for example via a cable. Up to eight sensors, for example, can be connected to the measuring transducer 10. The raw measured values of the sensor are processed in the measuring transducer 10, e.g., averaged and/or converted by means of a computation model to another variable—for example, the process variable to be determined—and possibly transmitted—to a control system, for example. The measuring transducer 10 comprises a data processing unit 12 with a memory 13 that is large enough to store a plurality of apps 11.

A sensor comprises at least one sensor element for detecting a measurand of process automation. The sensor is then for example a pH sensor, also known as ISFET, generally an ion-selective sensor, a sensor for measuring redox potential, the absorption of electromagnetic waves in the medium, for example with wavelengths in the UV, IR and/or visible ranges, oxygen, conductivity, turbidity, the concentration of non-metallic materials or temperature with the corresponding measured variable.

The measuring transducer 10 can be connected to a superordinate unit 20, such as a control system, via a cable. The measuring transducer 10 forwards the measurement data to a control system. In this case, the control system is designed as a process control system (PLC), PC, or server. For this purpose, the measuring transducer 10 transmits the data via a communication protocol that the control system can understand, for example a fieldbus, such as HART, Profibus PA, Profibus DP, Foundation Fieldbus, Modbus RS485, or also an Ethernet-based fieldbus, such as EtherNet/IP, Profinet, or Modbus/TCP. This case is not shown here.

The measuring transducer 10 comprises a display 7 and one or more operating elements 8, e.g., keys, knobs or rotary knobs, buttons or soft keys, via which the measuring transducer 10 can be operated. Measured data of the sensor are, for example, displayed by the display 7. The sensor can likewise be configured and parameterized via the operating elements 8 and the corresponding view on the display 7. The display 7 may also be designed as a touch display; the operating elements 8 can then also be part of the touch display, viz., as touch operating elements. The measuring transducer 10 comprises the data processing unit 12. The measuring transducer 10 can also comprise an SD card slot 9 via which apps can be loaded onto the measuring transducer 10. The measuring transducer 10 can also comprise one or more wireless modules, such as Bluetooth, mobile radio (2G, 3G, 4G, 5G) or other, possibly also wireless, bus protocols, such as WirelessHART, by means of which apps 11 can be loaded.

As mentioned, the measuring transducer 10 or the sensors connected thereto can be operated and parameterized via the operating elements 8. To this end, a menu or the menu structure is shown on the display 7. The menu structure describes the hierarchy, navigation, and texts of the various menu pages that are shown on the display 7. The menu structure makes it possible to select the desired command from an offering and to have it executed.

The menu structure comprises the entirety of all menu pages and the navigation therein. The menu structure thus describes the hierarchy, navigation, and texts of the various menu pages that are shown on the display of the measuring transducer, in order to guide the user. The menu structure allows for selecting from an offering and manipulating or executing a desired setting or a command. Adjustments, both on the measuring transducer and for the field device connected thereto (for example, the sensor), are made via the menu structure. The term “menu navigation” or “menu system” can also be used synonymously with “menu structure.”

A menu page is a collection of elements that can be static texts, parameters, or links to other menu pages.

A menu element is a single graphical or textual element on a menu page.

A menu description is the code that defines the individual menu pages.

The above-mentioned measuring transducer 10 is relatively powerful with a large display 7 and a plurality of control elements 8 with buttons and a rotary/push switch (“high-end transmitter”). However, the concept according to the present disclosure is also applicable to less powerful measuring transducers, generally terminals. “Low-end transmitters,” for example, only have a small or medium-sized monochrome display with for example only one or two buttons.

The concept according to the present disclosure is explained below using an application for fill level display and monitoring as an example: the variables of interest here are the current fill level and an upper and lower limit value for the fill level.

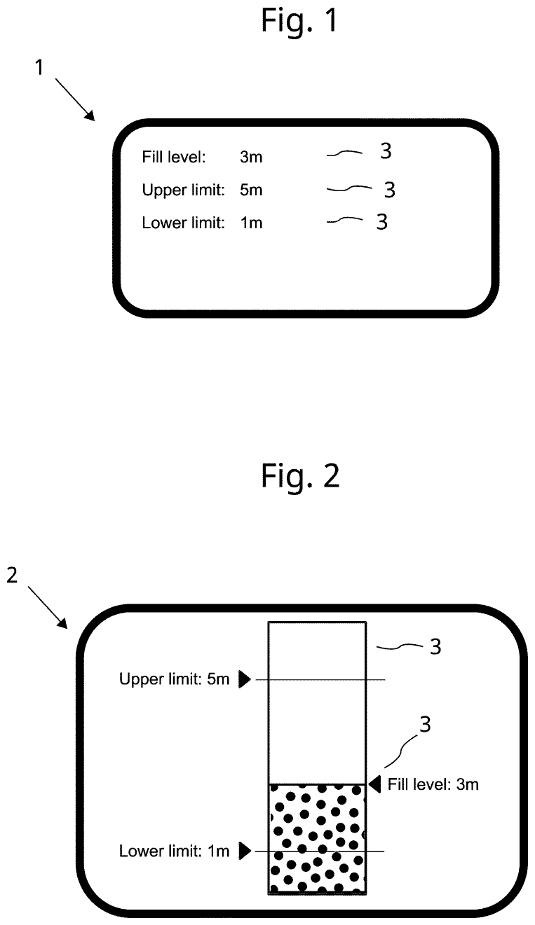

Version 1 of the app is based on version A of the menu system and uses purely textual menu elements 3 to display information. FIG. 1 shows this with a base set of menu elements 3. All elements 3 of version A of the menu system can be easily displayed even on low-end transmitters.

Version B of the menu system is being completed, which includes a bar graph as a new menu element. This is shown in FIG. 2. However, bar graphs can only be displayed on high-end transmitters.

Version 2 of the app offers the following improvements: increased precision and significantly improved performance in calculating the fill level and use of the bar graph to display information. A bar graph is a menu element 3 and consists of the sub-elements “fill bar” and indicator arrows as well as text labels appended thereto. Other possible menu elements are diagrams, graphs, charts with or without superimposed text, etc.

Due to the improved precision and performance of the fill level calculation, version 2 of the app should also be used on existing low-end transmitters. However, these transmitters still use version A of the menu system and may not display bar graphs even after a software update to version B.

Without appropriate measures, version 2 of the app would only be usable on transmitters that have at least version B of the menu system and a display system suitable therefor. The only way to prevent incompatibility with existing systems would be to forgo new, extended features in the menu system, which would not be in the spirit of continuous improvement of user interfaces or product features of the associated system.

The present application explains and claims a solution thereto. This essentially consists of three parts:
1. Definition of a universal base set of menu elements
2. For extended menu elements: definition of an alternative description solely using menu elements from the base set
3. Compatibility-preserving coding when extending existing menu elements

The first step is to identify the smallest possible universal set of menu elements that
are sufficient to implement all use cases of menu navigation (e.g., displaying information and editing settings), and
can be displayed on a minimal system (e.g., tiny monochrome display, two buttons).

Such a universal base set could contain:
menu pages linked in a tree structure, wherein a menu page is a list of rows
abstract navigation to navigate cyclically through the lines (no specification of specific hardware input options)
lines that represent a reference to a bottom or top page: “Selection” of the line leads to the referenced page
lines that represent pure text
lines that represent read-only parameters including the associated name/label text
lines that represent only editable parameters including the associated name/label text
lines that represent buttons to control actions
texts in greatly shortened and longer form

This universal base set must be mappable to all conceptually considered systems. On a very small system, the biggest problems naturally arise in terms of interaction and display options. Nevertheless, there are also possibilities such as number and text editors for which the above-mentioned editable parameters can be implemented, for example
a key for forward and backward navigation of the cursor within a number/text (short press moves cursor to the right, long press moves cursor to the left),
a key to select the next smaller digit/previous letter in the alphabet, and
a key to select the next larger digit/next letter in the alphabet.

Of course, high-end systems offer significantly improved display and navigation options for this universal base set. It is obvious that a navigator and a plurality of softkeys already bring a great improvement; a free multi-touch interface or a mouse/keyboard interface yields virtually unlimited freedom.

The elements of the universal base set should also be barrier-free, i.e., the elements of the base set should be as easily describable as possible, for example via speech output or Braille interfaces.

If a new element is introduced into a new version of the menu system, it must be defined for this new menu element how the information shown therein can alternatively be shown solely using elements from the universal base set.

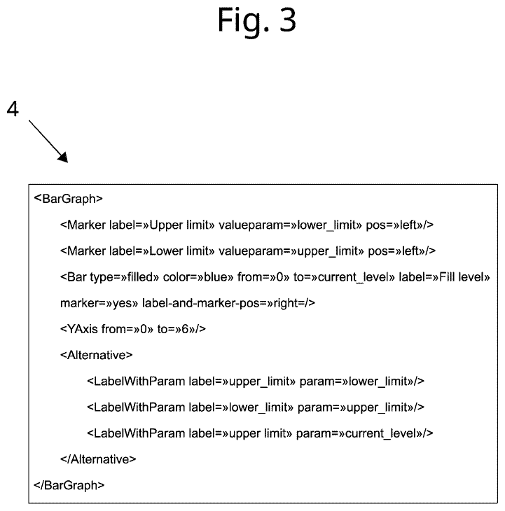

For the bar graph of FIG. 2, a portion of the menu system is shown in FIG. 3. For depiction, XML was chosen as an example for better structural comprehensibility. However, many other formats are possible for encoding the menu elements, such as JSON or more space-saving binary encodings (DER encoding or proprietary).

The bar graph to be displayed should contain two markers on the left for the upper and lower limits. The position of the markers on the Y-axis is determined dynamically based on the setting values of “lower_limit” and “upper_limit.” In addition, the bar to be displayed should be filled (on color displays, for example, in blue) and drawn from the range 0 to the current fill level (“current_level” is a parameter of the app and contains the currently calculated fill level). The range for the Y-axis was chosen to be 0 to 6.

Older menu systems that are not yet familiar with bar graphs, or transmitters that cannot display them due to hardware limitations, will find an alternative definition in the menu description of the bar graph, which definition must consist solely of elements from the universal base set (a tool could ensure this, for example when creating the app). All elements and constellations are permitted in this case that are permitted in a valid menu description consisting purely of universal basic elements. For example, an alternative description can also consist of a page structure with a plurality of subpages.

A menu system that is not familiar with a bar graph will render the alternative structure instead of the bar graph.

In the example, the alternative description consists of three lines of text analogous to the first image.

There are different approaches to defining the alternative description:
it can be defined individually for each instance of a menu element, e.g., the alternative descriptions for instances of bar graphs in a menu description can look completely different (e.g., three lines of text for bar graph A, a complete sub-page structure for bar graph B)
for each type of menu element, a parameterized schema can exist (template that describes how the alternative description looks structurally; the template is then filled with data upon each occurrence of a specific menu element), which describes how an instance of the menu element is mapped to an alternative description (example: every instance of a bar graph with three values basically has three lines of text with the corresponding values as an alternative description)
a combination of both approaches

The decision as to whether the transmitter must render the alternative description can be made based on various criteria, e.g.:
if the menu system on the transmitter is outdated, and the transmitter does not even recognize the corresponding element,
if it is permanently saved in the transmitter for certain menu elements (e.g., hard-coded in the source code) that the alternative description must be rendered, e.g., if the transmitter uses a display that is fundamentally unsuitable for graphic elements,
if technical possibilities or requirements are saved in the description of the menu element that the transmitter must fulfill for displaying, but which it does not (possibly temporarily) handle (e.g., the minimum display resolution, touch screen, color display, etc.),
if the extended menu element cannot be displayed without an impediment, but the user has activated the use of Braille-compatible output, for example.

In a further embodiment of the present disclosure, a menu element can have a plurality of alternative descriptions, wherein at least one of the alternative descriptions must consist exclusively of menu elements from the base set.

The selection of the alternative description to be rendered can be done in the following ways, for example:
the alternative descriptions have been pre-prioritized by the developer of the menu structure, e.g., in descending order according to the power of the menu items (alternative descriptions for high-end devices first, alternative descriptions for low-end devices next, alternative description consisting only of the base set last); the transmitter accordingly selects the first alternative description that can be displayed on the transmitter for the display of the prioritization,
the alternative descriptions are unsorted, and the transmitter uses its own internal, transmitter-specific implemented evaluation function to determine the best alternative description from the displayable ones.

The ever-possible ability to map menu elements of any complexity to elements of the universal base set is advantageous for supporting users with temporary or permanent limitations. For example, a user with severely reduced vision often uses, e.g., in addition to the graphical user interface, a supporting machine speech output that describes the displayed information. Due to the fundamental mapability of the elements of the universal base set to barrier-free interfaces, a system with suitable hardware capabilities can simultaneously use both the extended graphical representation and the descriptive machine speech output.

In the continuing development of the menu system, not only are new elements added, existing elements can also be extended with new optional attributes. For example, the menu element “Text line” could receive attributes for bold or color.

Care must be taken in this case to make such extensions are compatible. Existing attributes therefore must not be deleted and, their original semantics must be retained. Values in enumerations may not be changed, but may only be supplemented by additional supplementing attributes.

Let us assume that a menu element M was newly introduced with version X of the menu system. With version Y of the menu system, M was extended to M′. An app that was developed for menu system Y and uses M′ can still be displayed on a transmitter with menu system X, since the additional attributes in M′ are only optional. These represent additional information that is dispensable for the operation of the app or are simply improvements in the display of information. Instead of M′, the transmitter will display M.

The above description essentially refers to a “passive” alternative description, i.e., purely representational elements. In the following, a possibility is described to extend the basic concept also to “active” elements, i.e., elements for interaction, even by being replaced with simple basic elements.

The base set includes a way to interact with it programmatically via scripts; for the purposes of this document, this is referred to as “scripting capability.” This allows interaction with any element of the base set, which allows the mapping of more complex control elements to be implemented (elements of the base set, see above). The alternative description composes the more complex control element from a plurality of basic elements, and any interaction between these elements is described as a functionally equivalent alternative by the scripting capability.

Such a script is also part of the alternative description. The scripting capability includes variables, visibility of elements, (de)activation of elements, access to contents of number and text fields, changes to the contents of number and text fields, input validation functions, reactions to events such as pressing/releasing control elements, changing values, navigation, (de)selection of a menu element, etc.

This will be demonstrated using the example of a new menu element, often also called a “slider,” wherein the slider should be adjustable between two predefined limits (i.e., the lower and upper limit). This should be represented by an alternative description using the base set. This can be achieved by a number input field, a “down button,” an “up button,” an increment function, a decrement function, a validation function, an “upper limit” variable and a “lower limit” variable.

The “upper limit” and “lower limit” variables are linked by the alternative description to the data sources which are provided for the extended set of menu elements (e.g., parameter values or constants).

The increment function is linked to the up button via the “button pressed” event; it takes the numerical value from the input field, increments it if the current value has not yet reached the value of the upper limit variable, and then writes it back.

The decrement function is linked to the down button via the “button pressed” event; it takes the numerical value from the input field, decrements it if the current value has not yet reached the value of the lower limit variable, and then writes it back.

The validation function is used to monitor the input values in the numeric input field that the user enters directly; values outside the valid limits are not accepted.

1. A method for setting up a menu system on a terminal, wherein the terminal is designed at least to display information from a sensor of process automation technology including measured values of the sensor, the menu system comprising menu pages with menu elements, the method comprising the steps of:
providing a universal base set of menu elements,
wherein the base set is designed to implement all use cases of the menu system, including the display of information and editing of settings, and can be displayed on a minimal system;
providing at least a first extended set, and/or a higher-order extended set, of menu elements, and providing an alternative description therefor solely using the base set of menu elements;
checking the technical capabilities of the terminal device; and
displaying the information on the terminal device using the highest ordered extended set for which the terminal has the technical capabilities, or displaying the information using the next lowest ordered extended set, or the base set if the terminal is not capable of displaying an extended set.

2. The method according to claim 1,
wherein the base set is designed to be barrier-free, including Braille- and speech-output-compatible.

3. The method according to claim 1,
wherein the base set comprises at least one of the following base elements:
menu pages linked in a tree structure, where a menu page is a list of rows;
abstract navigation to navigate cyclically through the rows;
lines that represent a reference to a bottom or top page;
lines that represent pure text;
lines that represent read-only parameters including the associated name/label text;
lines that represent only editable parameters including the associated name/label text;
lines that represent buttons to control actions; or
texts in greatly shortened and longer form.

4. The method according to claim 1,
wherein the base set is designed for script creation and script processing, and the associated script is part of the alternative description.

5. The method according to claim 1,
wherein the script includes one or more of the following options: use of variables, visibility and (de)activation of elements, access to contents of number and text fields, changes to the contents of number and text fields, input validation functions, reactions to events, pressing/releasing control elements, changing values, navigation, and (de)selection of a menu element.

6. The method according to claim 1,
wherein the alternative description of an extended set is specified individually for each instance of a menu element.

7. The method according to claim 1, wherein menu elements are extended by optional attributes to make them backwards compatible.

8. A measuring transducer designed to set up a menu system on a terminal, including:
wherein the terminal is designed at least to display information from a sensor of process automation technology including measured values of the sensor, the menu system comprising menu pages with menu elements, the method comprising the steps of:
providing a universal base set of menu elements,
wherein the base set is designed to implement all use cases of the menu system, including the display of information and editing of settings, and can be displayed on a minimal system;
providing at least a first extended set, and/or a higher-order extended set, of menu elements, and providing an alternative description therefor solely using the base set of menu elements;
checking the technical capabilities of the terminal device; and
displaying the information on the terminal device using the highest ordered extended set for which the terminal has the technical capabilities, or displaying the information using the next lowest ordered extended set, or the base set if the terminal is not capable of displaying an extended set.

9. A computer program product comprising instructions that cause a device to perform at least some of the method steps according to at least claim 1.

10. A non-transitory computer-readable medium on which the computer program product of claim 9 is stored.
